(19) United States
(12) Patent Application Publication
(10) Pub. No.: US 2007/0052168 A1
(43) Pub. Date: Mar. 8, 2007

(54) Educational playing surface

(76) Inventor: Guylaine Bouchard, Laval (CA)

Correspondence Address: FAY SHARPE LLP, 1100 SUPERIOR AVENUE, SEVENTH FLOOR, CLEVELAND, OH, 44114, US

(21) Appl. No.: 10/559,756

(22) PCT Filed: Jun. 1, 2004
(86) PCT No.: PCT/CA04/00834

§ 371 Date: Aug. 30, 2006

(30) Foreign Application Priority Data
Jun. 6, 2003 (CA) 2,431,386

(51) Int. Cl. A63F 9/08; G09B 1/00

(52) U.S. Cl. 273/159; 434/170

(57) ABSTRACT

An educational aid for teaching students to recognize symbols such as the alphabet and numbers. The educational aid comprises a surface on which a plurality of gaming groups is disposed. Each gaming group comprises two or more gaming zones. The gaming zones each comprise a colour component and a symbol component. The gaming zones in each gaming group have the same colour component and different symbol components. When used the educational aid uses the contrast between the same colour components and the different symbol components in the gaming zones to draw the attention of the students to the symbol components.

### BACKGROUND OF THE INVENTION

The present relates to an educational aid for teaching the recognition of a set of symbols. More particularly the invention relates to an educational aid that can be used to play games that stimulate learning in children.

The use of various educational aids to teach people to recognize symbols, such as the alphabet is known in the prior art

Examples of educational aids can be seen in U.S. Pat. No. 6,419,495 to Lehmkuhl discloses an educational desk mat, which is used to show a student's progress and behaviour; U.S. Pat. No. 5,813,866 to Maeda which discloses a cloth chart for learning characters; and U.S. D370,818 to D'Alessio which discloses a design for an interlocking alphabet mat.

The use of games as education aids is also recognized. This use is seen as being especially successful with children since the use of games as educational aids makes the learning process more enjoyable, thus making the children more receptive to learn. As a result the prior art contains many examples of different educational aids in the form of games that can also be used for educational purposes.

It is also common for the educational games to be designed so as to require movement during the playing of a game. This not only provides exercise to the user of the educational aid, but also helps the user develop coordination and motor skills.

One example of an educational aid in the form of a game can be seen in U.S. Pat. No. 6,030,228 to Armstrong, which describes an educational system having a base or mat on which symbols and shapes may be mounted. The system also includes a plurality of marbles and figurines for being removably positioned adjacent to the symbols and shapes. This educational system provides teachers or instructors with an aid that can be used to make learning a game. The system does however have a disadvantage in that its construction is complex, thus potentially making it costly. Additionally, the system includes many small pieces which can easily be lost, or which can potentially provide a choking hazard for small children.

Another example of an educational aid in the form of a game can be seen in U.S. Pat. No. 5,971,761 to Tillman, Sr., which discloses an educational electronic baby mat. This invention displays a number of symbols on its surface, and has electronics that allow the symbols to be lighted up when a child presses on the appropriate surface. This device has the disadvantage of being difficult to manufacture.

Further examples of educational aids in the form of games can be seen in U.S. Pat. No. 5,507,495 to Kiss, which discloses games for teaching alphabet, number, colours, shapes, and math along with coordination and motor skills. The games disclosed in the Kiss reference are too complex and include too much information.

Finally, U.S. Pat. No. 1,459,996 to Schwarz describes an educational and amusement toy that comprises a spinning pointer and a disc with indicia thereon. For instance, the indicia may be the letters of the alphabet accompanied with a number indicating their placement in the alphabet. This game is quite limited in the education it can provide. Furthermore, the game does not provide any exercise to the person playing it.

As can be seen from the above examples, there are several examples of educational games in the prior art. However, as the examples have also shown none of these games provide a simple, educational aid, which can be used to teach a person to recognize a set of symbols, while also providing exercise.

### STATEMENT OF THE INVENTION

One aspect of the invention provides an educational aid which may comprise:
a support having a surface; and
a plurality of gaming groups disposed on said surface,
   each of said gaming groups comprising at least two gaming zones;
   each gaming zone comprising a symbol (e.g. indicia) component and a base colour component;
   the gaming zones of each gaming group having the same base colour component
   the gaming zones of each gaming group having different symbol components.

In a more particular embodiment each of said gaming groups may comprise a pair of (i.e. two) gaming zones.

In another particular embodiment each of said gaming zones may comprise an additional colour component.

In another particular embodiment each of said symbol components may be sandwiched between a respective base colour component and a respective additional colour component.

In another particular embodiment, for each gaming zone said base colour component and said additional colour component may be disposed in a predetermined colour sequence, and the gaming zones of each gaming group may have the same colour sequence; the predetermined colour sequence of each gaming group may be unique.

In another particular embodiment said gaming zones may be disposed around the periphery of a central area.

In another particular embodiment said central area may be substantially circular.

In another aspect the invention provides an educational aid kit, which may comprise:
at least two supports each having a surface; and
a plurality of gaming zones each disposed on a respective surface,
a plurality of gaming groups, each comprising at least two of said gaming zones;
   each gaming zone comprising a symbol (e.g. indicia) component and a base colour component;
   the gaming zones of each gaming group having the same base colour component
   the gaming zones of each gaming group having different symbol components.

### BRIEF DESCRIPTION OF THE DRAWINGS

FIG. 1 shows a first example embodiment of an educational aid according to the present invention.

FIG. 2 shows an enlarged view of one of a gaming zone used in the educational aid shown in FIG. 1.

FIG. 3 shows a second example embodiment of an educational aid according to the present invention.

FIG. 4 shows a third example embodiment of an educational aid according to the present invention.

FIG. 5 shows a fourth example embodiment of an educational aid according to the present invention.

FIG. 6 shows a fifth example embodiment of an educational aid according to the present invention.

FIG. 7 shows a sixth example embodiment of an educational aid according to the present invention.

FIG. 8 shows a seventh example embodiment of an education aid according to the present invention.

FIG. 9 shows an example of a fastening means, which may be used with the embodiment of the invention shown in FIG. 8.

FIG. 10 shows another example of a fastening means, which may be used with the embodiment of the invention shown in FIG. 8.

### DETAILED DESCRIPTION

The present invention relates to an educational aid for teaching students, most often young children, to recognize different symbols, in particular the alphabet.

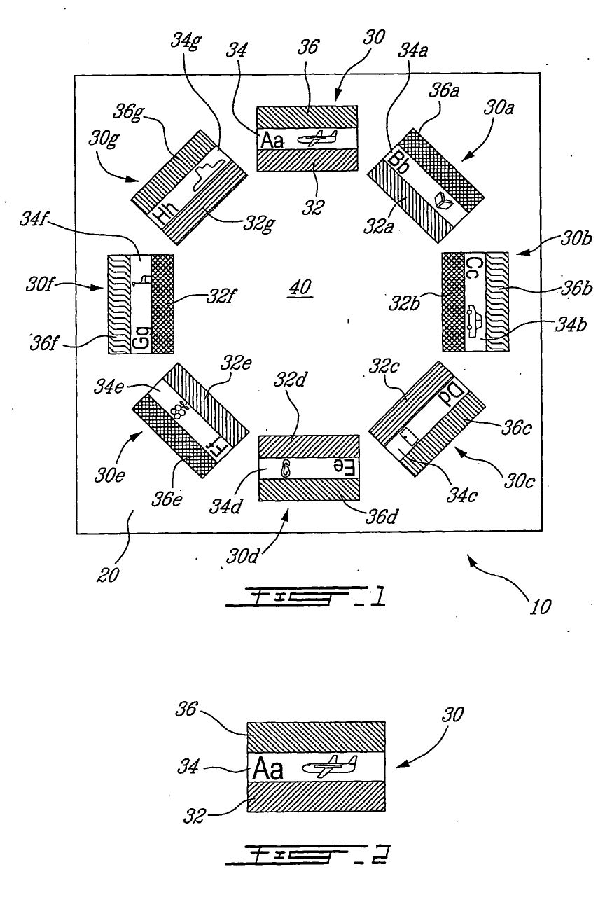

One example embodiment of an educational aid is shown in FIG. 1. The invention educational aid 10 comprises a base support having a surface 20 on which is disposed a plurality of gaming zones 30, 30a, 30b, 30c, 30d, 30e, 30f, and 30g, in a substantially circular pattern. As can be seen the educational aid 10 has eight gaming zones, other embodiments, however, may have a different number of gaming zones.

It should be noted that while the educational aid of the invention can accommodate any number of gaming zones, preferred embodiments have between 10 and 16 gaming zones. This range allows for a substantial number of symbols to be taught while not overloading a student. Furthermore, one aspect of the educational aid of the invention allows for the educational aid to be embodied as a large floor mat. In this embodiment the students playing a game using the educational aid will be able to stand on the gaming zones. Thus the gaming zones need to be large enough to accommodate the students.

The surface 20 may be defined by any appropriate or desired base member surface on 30 which the gaming zones 30 to 30g may be disposed. The surface 20 may for example be defined by a support such as a (flexible) floor mat.

The type of support used depends primarily on the way the educational aid 10 is to be used. For instance, if the educational aid 10 is to be used as a large game board on which the students stand and move around, then a large vinyl mat may be advantageous. Such a vinyl mat may be lightweight, easy to clean, and may be easily be put away for storage.

On the other hand, if desired an embodiment of the educational aid may be included in a dedicated play area (e.g. an outside playground). In this instance the support of the educational aid may be a sidewalk, or a concrete slab. In other aspects, such as if the educational aid is to be used on a smaller scale with the students using markers or playing pieces on the gaming zones, then a simple cardboard sheet might be appropriate.

The size of the surface 20 of the educational aid 10 may for example reflect how it is to be used. For instance, if the educational aid 10 is to be used as a large game board on the ground then the surface 20 must be large enough that the players can stand or sit on the gaming zones 30 to 30g.

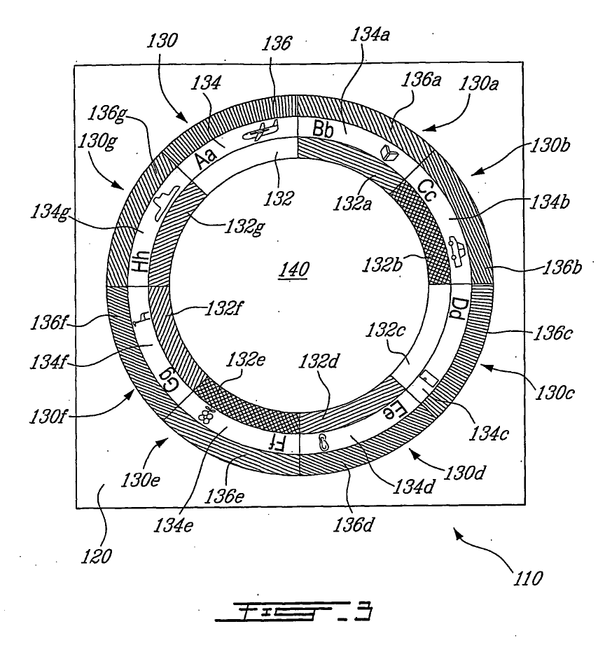

Moving on to FIG. 2, we can see an enlarged view of gaming zone 30. As can be seen the gaming zone 30 is made up of three components, which are disposed in a sandwich type sequence. These components are a base colour component 32 and an additional colour component 36 both of which are filled with colour (e.g. red and blue respectively). The specific colours filling base colour component 32 and additional colour component 36 may be any colour, or may be if desired the same colour.

In addition to the colour components 32 and 36 gaming zone 30 comprises symbol component 34, which is provided with a symbol or an indicia In this particular case the symbol component 34 is provided with an upper case and a lower case version of the letter ‘A’. Furthermore, the symbol component 34 is provided with a drawing of an airplane so as to help the students associate the letter ‘A’ with an object starting with the appropriate letter.

As can be seen the basic colour component 32, and the additional colour component 36 are disposed in a sequence thus, giving the gaming zone 30 a colour sequence.

Turning back to FIG. 1, we can see that all of the gaming zones 30 to 30g all have a basic colour component, an additional colour component and a symbol component, thus all have a colour sequence. In one particular example embodiment the gaming zones 30 to 30g may have basic colour components, additional colour components, and symbol components as set out in the below table:

| | | Symbol | |
|---|---|---|---|
| | | Component | Additional |
| | | (RefNumber: | Colour |
| | Basic Colour | UpperCase, | Component |
| | Component | LowerCase, | (RefNumber: |
| Gaming zone | (RefNumber: Colour) | Picture) | Colour) |
| 30 | 32: Red | 34: A, a, Airplane | 36: Blue |
| 30a | 32a: Blue | 34a: B, b, Book | 36a: Green |
| 30b | 32b: Yellow | 34b: C, c, Car | 36b: Red |
| 30c | 32c: Green | 34c: D, d, Door | 36c: Yellow |
| 30d | 32d: Red | 34d: E, e, Ear | 36d: Blue |
| 30e | 32e: Blue | 34e: F, f, Flower | 36e: Green |
| 30f | 32f: Yellow | 34f: G, g, Giraffe | 36f: Red |
| 30g | 32g: Green | 34g: H, h, Hat | 36g: Yellow |

Furthermore, as can be seen for each gaming zone having a particular colour sequence, there is another gaming zone, which has the same colour sequence only differing in which indicia are used to mark the different symbol components. For instance, gaming zone 30 has the same colour sequence as gaming zone 30d. The only difference is that game zone 30 is marked with the letter ‘A’ and gaming zone 30d is marked with the letter ‘E’. Similarly, gaming zone 30a has the same colour sequence as gaming zone 30e; 30b as 30f; and 30c as 30g.

In this way the different gaming zones 30 to 30g are grouped by their colour sequence. As will be described below, this linking may be used when a game using the educational aid 10 is played, by asking a player to move from a gaming zone to another gaming zone in the same gaming group.

It should also be noted that the gaming zones 30 to 30g are disposed such that the indicia in their symbol component face inwards. This construction allows a player standing in one gaming zone to read the indicia of the other gaming zones.

While educational aid 10 has indicia representing the letters of the alphabet, in other embodiments the indicia may represent any appropriate set of symbols, which it is desirable to learn or teach, e.g. numbers and shapes.

Referring to the embodiment of the educational aid shown in FIG. 1, a game using the educational aid 10 will now be described.

To begin play the educational aid 10 is placed on the ground or the floor. A student then uses a random selection mechanism (not shown) to select a gaming zone. The type of random selection mechanism used is not important, and may be any appropriate mechanism, examples include, specially made dice, a spinner, cue cards, or simply a teacher standing by and telling the student which gaming zone to go to.

After the gaming zone has been selected, the student moves to the appropriate gaming zone. For the purposes of demonstration assume gaming zone 30 was selected. The student upon getting to gaming zone 30 would notice the colours in the colour components 32 and 36 and the indicia in symbol component 34. The student would then be instructed to locate the gaming zone with the same colour sequence, and move to this gaming zone. In this instance, gaming zone 30d, which has the same colour in its colour components as gaming zone 30. The student's attention would now be especially drawn to the indicia of the gaming zone 30d since the indicia are contrasted with the indicia of gaming zone 30. That is the similarities between gaming zone 30 and 30d highlight the difference that is the indicia that is being taught.

Additionally, the student would typically be told to stand on the symbol component 30 facing inwards. In this way, directional concepts such as in front and behind are reinforced in the student, as the student needs to be aware of the part of the colour sequence in front of him or her, as well as the part of the colour sequence that is behind him or her.

In the next step the student would either use the random selection mechanism again if playing alone, or the next student would use the random selection mechanism.

If multiple students are playing the game, and a first student lands on a gaming zone containing a second student, then the students would switch places, with the first student going to the new gaming zone and the second student going to the first student's old gaming zone.

The game will continue with the students each taking turns using the random selection mechanism for as long as desired.

The type of movement used by the students when moving between the gaming zones may also be varied. Selection of what type of movement to use (running, hopping, walking, etc.) may be included in the random selection mechanism which selects the gaming zone, a second random selection mechanism may be provided, or a teacher may simply tell the student what type of movement to use.

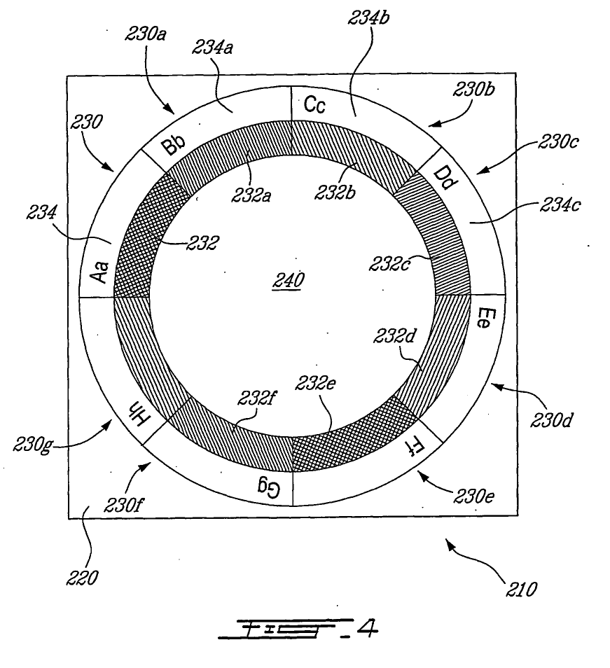

Moving on to FIGS. 3 to 6, different example embodiments of the educational aid of the invention may be seen.

FIG. 3 shows a second example embodiment of an educational aid 110 comprising a surface 120 on which gaming zones 130 to 130g have been printed so as to form a complete circle. In this embodiment the gaming zones 130 to 130g are divided into three consecutive components. For instance gaming zone 130 is divided into a basic colour component 132, and symbol component 134, and an additional colour component 136.

In one particular example embodiment the gaming zones 130 to 130g may have basic colour components, additional colour components, and symbol components as set out in the below table:

| | Basic Colour | Symbol Component | Additional Colour |
|---|---|---|---|
| | Component | (RefNumber: UpperCase, | Component |
| Gaming Zone | (RefNumber: Colour) | LowerCase, Picture) | (RefNumber: Colour) |
| 130 | 132: Red | 134: A, a, Airplane | 136: Blue |
| 130a | 132a: Blue | 134a: B, b, Book | 136a: Green |
| 130b | 132b: Yellow | 134b: C, c, Car | 136b: Red |
| 130c | 132c: Red | 134c: D, d, Door | 136c: Blue |
| 130d | 132d: Blue | 134d: E, e, Ear | 136d: Green |
| 130e | 132e: Yellow | 134e: F, f, Flower | 136e: Red |
| 130f | 132f: Green | 134f: G, g, Giraffe | 136f: Yellow |
| 130g | 132g: Green | 134g: H, h, Hat | 136g: Yellow |

As may be seen, gaming zone 130 has the same basic colour component and additional colour component as 130c; gaming zone 130a as gaming zone 130d; gaming zone 130b as gaming zone 130e; and gaming zone 130f as gaming zone 130g.

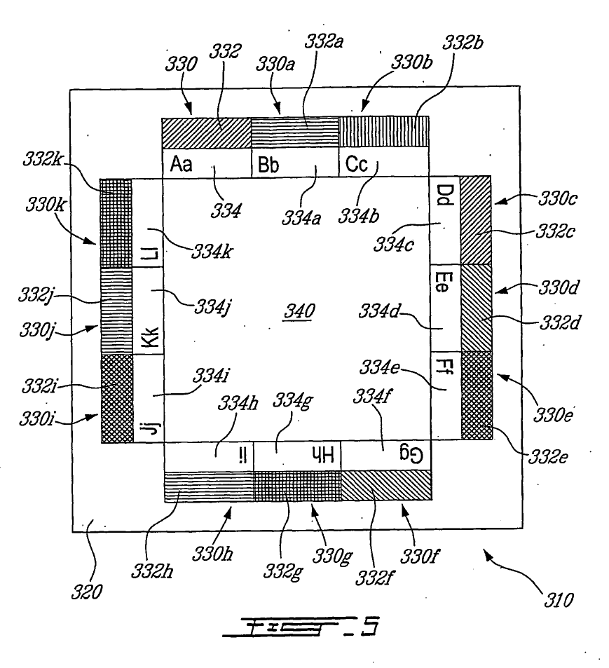

FIG. 4 shows a third example embodiment of an educational aid 210. This embodiment also comprises a surface 220 on which gaming zones 230 to 230g are disposed. As with the second example embodiment 110 (see FIG. 2), the gaming zones 230 to 230g are disposed so as to form a complete circle on the surface 220. However, in this example embodiment the gaming zones 230 to 230g are only divided into two components, that is one basic colour component and one symbol component.

In one particular example embodiment the gaming zones 230 to 230g may have basic colour components, and symbol components as set out in the below table:

| | | Symbol |
|---|---|---|
| | Basic Colour Component | Component (RefNumber: |
| Gaming zone | (RefNumber: Colour) | UpperCase, LowerCase) |
| 230 | 232: Red | 234: A, a |
| 230a | 232a: Blue | 234a: B, b |
| 230b | 232b: Green | 234b: C, c |
| 230c | 232c: Blue | 234c: D, d |
| 230d | 232d: Yellow | 234d: E, e |
| 230e | 232e: Red | 234e: F, f |
| 230f | 232f: Green | 234f: G, g |
| 230g | 232g: Yellow | 234g: H, h |

As may be seen, gaming zone 230 has the same basic colour component as 230e; gaming zone 230a as gaming zone 230c; gaming zone 230b as gaming zone 230f; and gaming zone 230d as gaming zone 230g.

FIG. 5 shows a fourth example embodiment of an education aid 310. This embodiment also comprises a surface 320, and a plurality of gaming zones 330 to 330k. In this embodiment the gaming zones 330 to 330k are disposed in a substantially rectangular shape.

In one particular example embodiment the gaming zones 330 to 330k may have basic colour components, and symbol components as set out in the below table:

| | | Symbol |
|---|---|---|
| | Basic Colour Component | Component (RefNumber: |
| Gaming zone | (RefNumber: Colour) | UpperCase, LowerCase) |
| 330 | 332: Red | 334: A, a |
| 330a | 332a: Blue | 334a: B, b |
| 330b | 332b: Green | 334b: C, c |
| 330e | 332c: Yellow | 334c: D, d |
| 330d | 332d: Red | 334d: E, e |
| 330e | 332e: White | 334e: F, f |
| 330f | 332f: Yellow | 334f: G, g |
| 330g | 332g: Black | 334g: H, h |
| 330h | 332h: Blue | 334h: I, i |
| 330i | 3321: White | 3341: J, j |
| 330j | 332j: Green | 334j: K, k |
| 330k | 332k: Black | 334k: L, l |

As may be seen, gaming zone 330 has the same basic colour component as 330d; gaming zone 330a as gaming zone 330h; gaming zone 330b as gaming zone 330j; gaming zone 330c as gaming zone 330f; gaming zone 330e as gaming zone 330i; and gaming zone 330g as gaming zone 330k.

Referring to FIGS. 1, 3, 4, and 5 we can see that all of the educational aids 10, 110, 210, and 310 have their gaming zones disposed so that the indicia in their symbol component face towards the centre of the surfaces 20, 120, 220, and 320. The gaming zones have also been disposed on the periphery of central areas 40, 140, 240, and 340 of the surfaces 20, 120, 220, and 320. Furthermore, in the educational aids 10, 110, and 210 the central areas 40, 140, and 240 are substantially circular.

Each of the educational aids 10, 110, 210, and 310 are particularly advantageous in the aspect of the invention where the educational aid is to be placed on the ground or floor, and where the students are to stand on the gaming zones. In this aspect it is preferable to have a central area which does not contain any gaming zones, since it allows the student a greater overview of the surface, and ensures the chance that another student blocking the view. Thus the students can more easily find the next gaming zone that they are to move to.

Furthermore, if a teacher wishes to address the students during the game, he or she can easily stand in the central area and thus have all the students have their attention on him or her. If the teacher wishes to speak for an extended period of time he or she may have the students sit down on their respective gaming zones, while he or she speaks. In this instance the placement of the gaming zones shown in FIG. 1, FIG. 3, and FIG. 4, may be advantageous, since it is more natural for people to gather in a substantially circular formation rather than a square formation such as in FIG. 5.

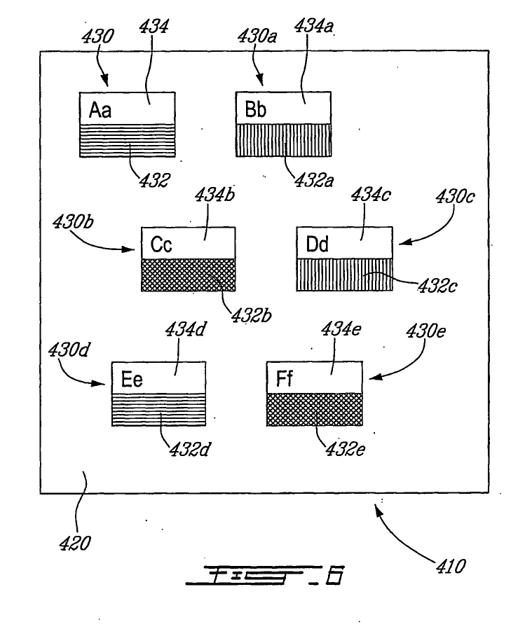

FIG. 6 shows a fifth example embodiment of an educational aid 410. The educational aid 410 also comprises a surface 420 having a plurality of gaming zones 430 to 430e disposed thereon:

In one particular example embodiment the gaming zones 430 to 430e may have basic colour components, and symbol components as set out in the below table:

| | | Symbol |
|---|---|---|
| | Basic Colour Component | Component (RefNumber: |
| Gaming zone | (RefNumber: Colour) | UpperCase, LowerCase) |
| 430 | 432: Red | 434: A, a |
| 430a | 432a: Blue | 434a: B, b |
| 430b | 432b: Green | 434b: C, c |
| 430c | 432c: Blue | 434c: D, d |
| 430d | 432d: Red | 434d: E, e |
| 430e | 432e: Green | 434e: F, f |

As may be seen, gaming zone 430 has the same basic colour component as 430d; gaming zone 430a as gaming zone 430c; and gaming zone 430b as gaming zone 430e.

Unlike the previous embodiments shown in FIGS. I, 3, 4, and 5 the embodiment shown in FIG. 6 does not have the gaming zones 430 to 430e disposed around a central area.

The configuration of the educational aid 410 may be used if the educational aid 410 is to be placed on a desk or a table and the student is to a move marker or playing piece on the educational aid 410. In this instance the configuration of the gaming zones 430 to 430e might be advantageous since the student would be looking at the educational aid 410 from only one direction. Thus, having all the indicia of the gaming zones 430 to 430e face the same direction would make them easier to read.

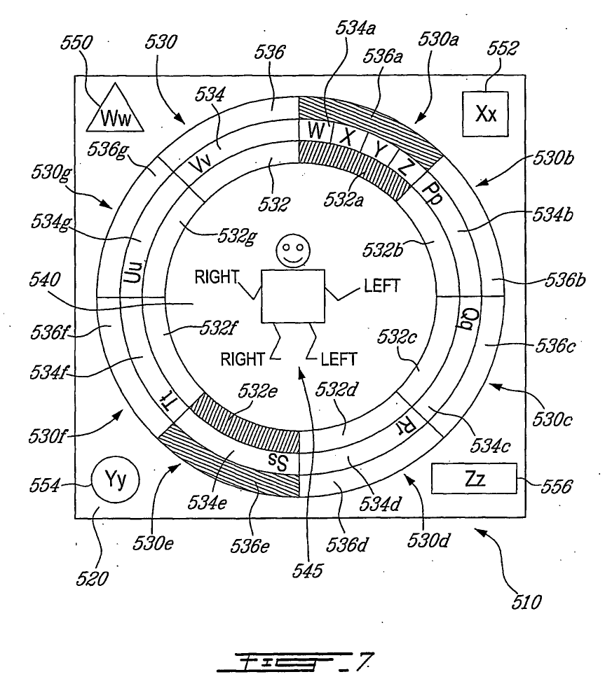

Moving on to FIG. 7, we see a sixth example embodiment of an educational aid 510. The educational aid 510 again comprises a surface 520 on which is disposed a plurality of gaming zones 530 to 530g, one of which is an intermediate gaming zone 530a as is explained below. The gaming zones 530 to 530g are in this embodiment disposed in a circle around the periphery of circular central area 540 in which is disposed a FIG. 545. The FIG. 545 is in the shape of a person and has spatial concepts such as left and right labelled. This figure is provided so that students using the educational aid 510 become familiar with these concepts through extended exposure.

In one particular example embodiment the gaming zones 530 to 530g may have basic colour components, additional colour components, and symbol components as set out in the below table:

| | Basic Colour | Symbol Component | Additional Colour |
|---|---|---|---|
| Gaming | Component | (RefNumber: UpperCase, | Component |
| zone | (RefNumber: Colour) | LowerCase) | (RefNumber: Colour) |
| 530 | 532: Blue | 534: V, v | 536: Green |
| 530a | 532a: Red | 534a: w, x, y, z (See below) | 536a: Blue |
| 530b | 532b: Yellow | 534b: P, p | 536b: Red |
| 530e | 532c: Yellow | 534c: Q, q | 536c: Red |
| 530d | 532d: Green | 534d: R, r | 536d: Yellow |
| 530e | 532e: Red | 534e: S, s | 536e: Blue |
| 530f | 532f: Green | 534f: T, t | 536f: Yellow |
| 530g | 532g: Blue | 534g: U, u | 536g: Green |

As may be seen, gaming zone 530 has the same basic colour component and additional colour component as 530g; gaming zone 530a as gaming zone 530e; gaming zone 530b as gaming zone 530c; and gaming zone 530d as gaming zone 530f.

In addition to the gaming zones 530 to 530g the educational aid 510 has also been provided with auxiliary gaming zones 550, 552, 554, and 556. The auxiliary gaming zones are all given different shapes and are each marked with different indicia. For instance, auxiliary gaming zone 550 is a triangle shape and is marked with the letters ‘W’ and ‘w’; auxiliary gaming zone 552 is a square shape and is marked with the letters ‘X’ and ‘x’; auxiliary gaming zone 554 is a circle shape and is marked with the letters ‘Y’ and ‘y’ and auxiliary-gaming zone 556 is a rectangle shape and is marked with the letters ‘Z’ and ‘z’.

The auxiliary gaming zones 550 to 556 may also be given respective colours to help differentiate them. For instance, auxiliary gaming zone 550 could be red, auxiliary gaming zone 552 could be blue, auxiliary gaming zone 554 could be green, and auxiliary gaming zone 556 could be yellow.

The auxiliary gaming zones 550, 552, 554, and 556 allow for the educational aid 510 to teach recognition of the symbols in the symbol components of the gaming zones, (in this case the letter of the alphabet), and recognition of simple shapes at the same time.

The auxiliary gaming zones may be integrated in the game by the use of an intermediary gaming zone 530a. That is a gaming zone, which is disposed not to act as an intermediary between the play area containing the “normal” gaming zones 530 and 530b, and the auxiliary gaming zones 550 to 556.

To that effect intermediary gaming zone 530a may have a basic colour component 532a (e.g Red), and additional colour component 536a (e.g. Blue), and a symbol component 534a, just like the other gaming zones 530 and 530b.

However, intermediate gaming zone 530a may be different in that symbol component 534a may be marked with indicia corresponding to the indicia of the auxiliary gaming zones 550, 552, 554, and 556.

The auxiliary gaming zones 550, 552, 554, and 556 then come into play whenever during a game played with the educational aid 510, and a player arrives at intermediate gaming zone 530a. Either by going directly to it or by way of gaming zone 530e, which is in the same gaming group. When the player arrives at the intermediate gaming zone 530a, he or she may be then told by a teacher to locate the auxiliary gaming zone having a particular shape and then move to the appropriate auxiliary gaming zone. In this way the player may be taught to recognize simple shapes.

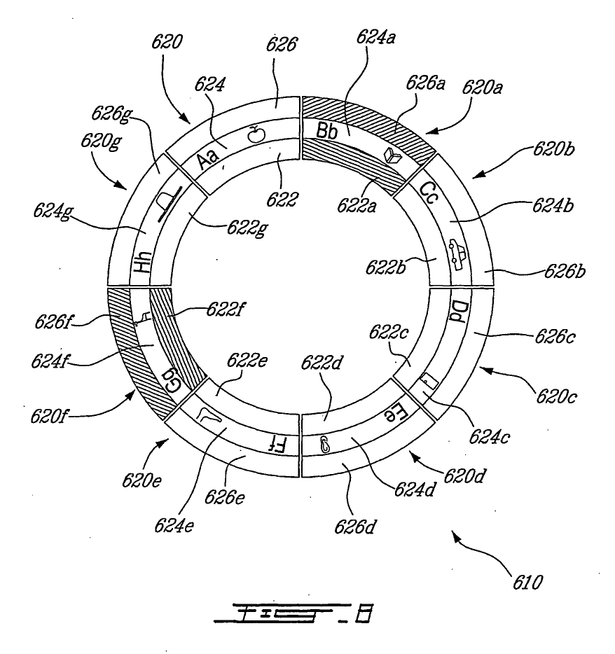

Moving on to FIG. 8, we can see an example embodiment of an educational aid 610 according to the invention, in which the educational aid 610 comprises multiple supports.

In this embodiment the educational aid 610 comprises a plurality of gaming zones 620 to 620g, each of which is disposed on a separate support. The supports may be any appropriate material. In one example, they could be individual pieces of cardboard.

In one particular example embodiment the gaming zones 620 to 620g may have basic colour components, additional colour components, and symbol components as set out in the below table:

| | Basic | | Additional |
|---|---|---|---|
| | Colour | | Colour |
| | Component | Symbol Component | Component |
| Gaming | (RefNumber: | (RefNumber: UpperCase, | (RefNumber: |
| zone | Colour) | LowerCase, Picture) | Colour) |
| 620 | 622: Blue | 624: A, a, Airplane | 626: Green |
| 620a | 622a: Red | 624a: B, b, Book | 626a: Blue |
| 620b | 622b: Yellow | 624b: C, c, Cm | 626b: Red |
| 620e | 622c: Green | 624c: D, d, Door | 626c: Yellow |
| 620d | 622d: Blue | 624d: E, e, Ear | 626d: Green |
| 620e | 622e: Yellow | 624e: F, f, Foot | 626e: Red |
| 620f | 622f: Red | 624f: G, g, Giraffe | 626f: Blue |
| 620g | 622g: Green | 624g: H, h, Hat | 626g: Yellow |

As may be seen, gaming zone 620 has the same basic colour component and additional colour component as 620d; gaming zone 620a as gaming zone 620f; gaming zone 620b as gaming zone 620e; and gaming zone 620c as gaming zone 620g.

The educational aid 610 may be designed similarly to the previously shown educational aids, the main difference being the lack of a support common to all the gaming zones 620 to 620g. The lack of a common support allows education aid 610 to be used for additional games, as well as allowing the educational aid 610 to be stored in a compact manner.

In this embodiment, the students may for example carry the gaming zones 620 to 620g rather than stand on them. This would allow the students to place their respective gaming zones next to another student's gaming zone and compare the differences. Or if the gaming zones 620 to 620g were placed on the floor, then it would allow the teacher to vary the order of the gaming zones 620 to 620g within the circle. This would reduce the likelihood of the students learning to recognize the proper gaming zones by its placement rather than its colour zones or symbols.

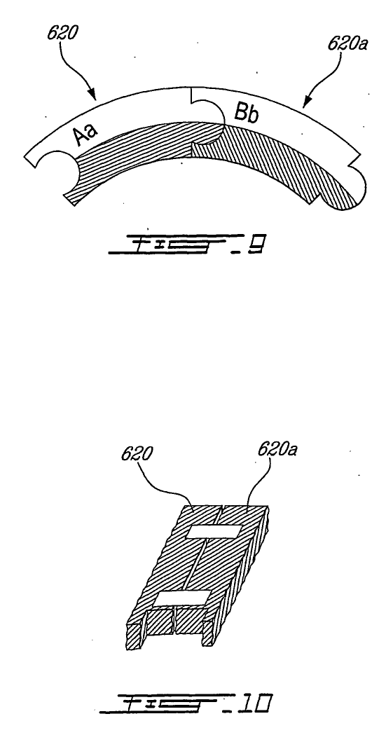

Educational aid 610 may also be outfitted with fastening means (See FIGS. 9 and 10), which could be used to releasably bind the gaming zones 620 to 620g together. For instance the side edges of the gaming zones 620 to 620g may be made to resemble pieces in jigsaw puzzle (See FIG. 9). Other possible fastening means may include clips which attach to two separate gaming zones (See FIG. 10), or any other appropriate fastening means.

After the games are finished, the individual pieces of educational aid 610 may be stacked together and easily stored in a box or cabinet.

Although the present invention has been described in connection with example embodiments thereof, many variations and modifications will be apparent to those skilled in the art.

For instance, while the example embodiments shown have only had only one symbol component and a maximum of two colour components, the invention encompasses any number of symbol components and colour components.

Also, while the example embodiments have all been shown with each gaming group comprising only a pair of gaming zones, other embodiments may have any number of gaming zones in their gaming groups. For instance, each gaming group in an educational aid may easily contain three gaming zones. Or in another example each gaming group may comprise four gaming zones.

1. An educational aid comprising:
a support having a surface; and
a plurality of gaming groups disposed on said surface, each of said gaming groups comprising at least two gaming zones, each gaming zone comprising a symbol component and a base colour component, the gaming zones of each gaming group having the same base colour component, the gaming zones of each gaming group having different symbol components.

2. An educational aid as described in claim 1, wherein each of said gaming groups comprises a pair of gaming zones.

3. An educational aid as described in claim 1, wherein each of said gaming zones comprises an additional colour component.

4. An educational aid as described in claim 3, wherein each of said symbol components is sandwiched between a respective base colour component and a respective additional colour component.

5. An educational aid as described in claim 4 wherein for each gaming zone said base colour component and said additional colour component are disposed in a predetermined colour sequence, and the gaming zones of each gaming group have the same colour sequence, the predetermined colour sequence of each gaming group being unique.

6. An educational aid as described in claim 5 wherein said gaming zones are disposed around the periphery of a central area.

7. An educational aid as described in claim 6, wherein said central area is substantially circular.

8. An educational aid kit comprising:
at least two supports each having a surface; and
a plurality of gaming zones each disposed on a respective surface,
a plurality of gaming groups, each comprising at least two of said gaming zones;
each gaming zone comprising a symbol component and a base colour component,
the gaming zones of each gaming group having the same base colour component,
the gaming zones of each gaming group having different symbol components.

9. An educational aid as described in claim 1 wherein said gaming zones are disposed around the periphery of a central area.

10. An educational aid as described in claim 9, wherein said central area is substantially circular.

11. An educational aid as described in claim 2 wherein each of said gaming zones comprises an additional colour component.

12. An educational aid as described in claim 11, wherein each of said symbol components is sandwiched between a respective base colour component and a respective additional colour component.

13. An educational aid as described in claim 12 wherein for each gaming zone said base colour component and said additional colour component are disposed in a predetermined colour sequence, and the gaming zones of each gaming group have the same colour sequence, the predetermined colour sequence of each gaming group being unique.

14. An educational aid as described in claim 13 wherein said gaming zones are disposed around the periphery of a central area.

15. An educational aid as described in claim 14, wherein said central area is substantially circular.

16. An educational aid as described in claim 3 wherein for each gaming zone said base colour component and said additional colour component are disposed in a predetermined colour sequence, and the gaming zones of each gaming group have the same colour sequence, the predetermined colour sequence of each gaming group being unique.

17. An educational aid as described in claim 16 wherein said gaming zones are disposed around the periphery of a central area.

18. An educational aid as described in claim 17, wherein said central area is substantially circular.

19. An educational aid as described in claim 11 wherein for each gaming zone said base colour component and said additional colour component are disposed in a predetermined colour sequence, and the gaming zones of each gaming group have the same colour sequence, the predetermined colour sequence of each gaming group being unique.

20. An educational aid as described in claim 19 wherein said gaming zones are disposed around the periphery of a central area.

21. An educational aid as described in claim 20 wherein said central area is substantially circular.
